(19) United States
(12) Patent Application Publication
(10) Pub. No.: US 2009/0041344 A1
(43) Pub. Date: Feb. 12, 2009

(54) Methods and Systems for Determining a Background Color in a Digital Image

(76) Inventors: Richard John Campbell, Camas, WA (US); Jon M. Speigle, Vancouver, WA (US)

Correspondence Address: Kristine Elizabeth Matthews, 19302 SE 31st Drive, Camas, WA, 98607, US

(21) Appl. No.: 11/835,684

(22) Filed: Aug. 8, 2007

(51) Int. Cl. G06K 9/00

(52) U.S. Cl. 382/164

(57) ABSTRACT

Aspects of the present invention are related to methods and systems for determining a background color in a digital image.

### FIELD OF THE INVENTION

Embodiments of the present invention comprise methods and systems for determining a background color in a digital image.

### BACKGROUND

Many digital image processing enhancements that improve the visual quality of a digital image rely on the accurate identification of different image regions in the digital image. Additionally, accurate determination of various regions in an image is critical in many compression processes.

### SUMMARY

Embodiments of the present invention comprise systems and methods for determining a local background color for a pixel in an image by summarizing the color values in a color buffer wherein the color values in the color buffer have been selectively added to the color buffer from the image data based on criterion which may be related to edge density, image uniformity, non-local color information, foreground color estimate and other selection criterion.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 depicts an exemplary digital image comprising a page background and three local background regions;

FIG. 2 depicts an exemplary background image corresponding to the exemplary digital image of FIG. 1;

FIG. 3 is a diagram of embodiments of the present invention comprising a data selector and a color estimator;

FIG. 4 is a diagram of embodiments of the present invention comprising a data selector, a color estimator and a selection criterion;

FIG. 5 is a chart showing embodiments of the present invention comprising selecting pixels for entry into a color buffer based on the distance of the pixel from an image edge;

FIG. 6 is a diagram of embodiments of the present invention comprising filling and expanding edge detection results prior to using the edge detection results as a selection criterion;

FIG. 7 is a diagram of embodiments of the present invention comprising a data selector, a color estimator and a uniformity measure calculator;

FIG. 8 is a diagram of embodiments of the present invention comprising a uniformity measure calculator and an edge measure calculator;

FIG. 9 is a diagram of embodiments of the present invention comprising a uniformity measure calculator, an edge measure calculator and a weighting calculator;

FIG. 10 is a diagram of embodiments of the present invention comprising a weighting calculator;

FIG. 11 is a diagram of embodiments of the present invention comprising multiple color buffers and color buffer selection based on non-local analysis; and

FIG. 12 is a diagram of embodiments of the present invention comprising a foreground color estimator.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention, but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

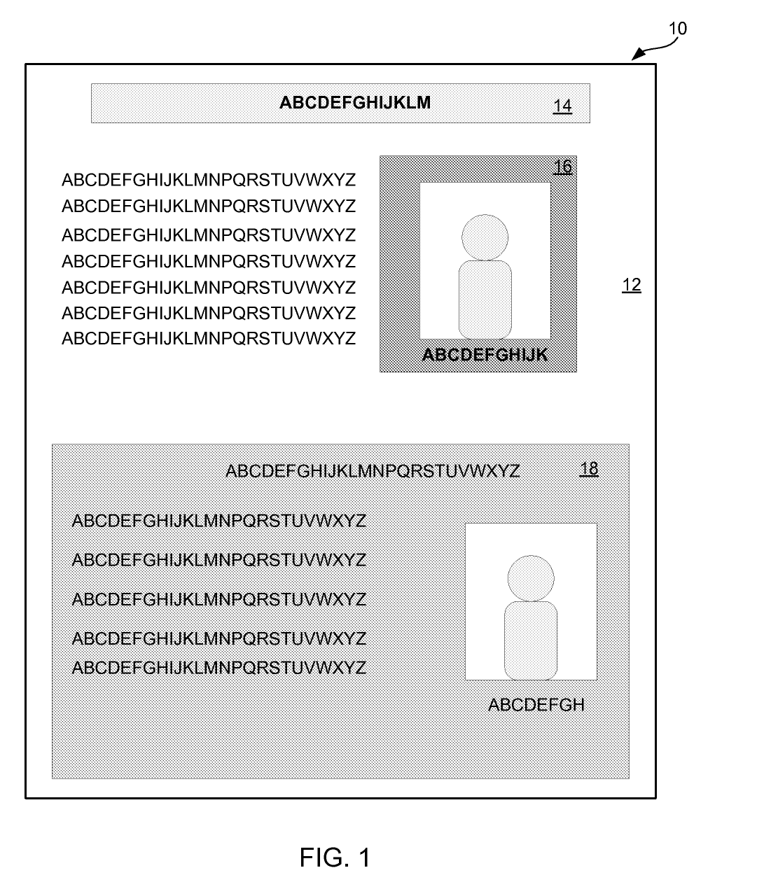

FIG. 1 shows an exemplary image 10. This exemplary document image 10 comprises several regions including: a page background region 12, a first local background region 14; a second local background region 16 and a third local background region 18. The page background region, also considered the global background region, may refer to the largely homogeneous region of the color of the paper on which a document may have been printed or the color of the background on which an electronically generated document may have been composed. A local background region may be a local region of homogeneous texture or color. Color may be described in any color space. Exemplary color spaces may include RGB, sRGB, CMYK, HSV, YUV, YIQ, CIE L*a*b*, YCbCr and other color spaces including gray-scale and luminance only color spaces.

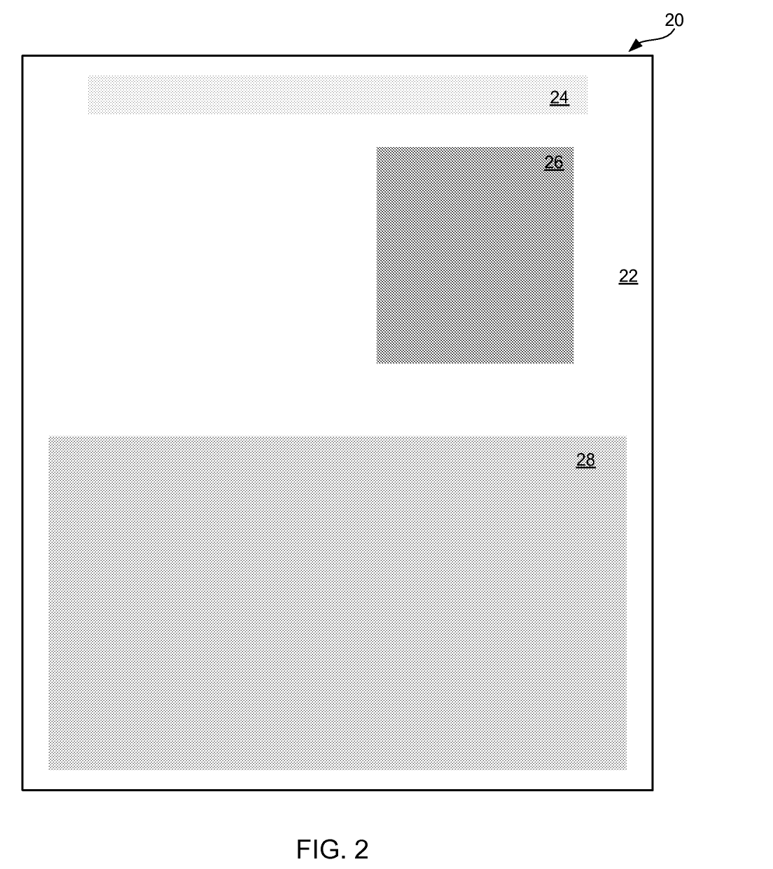

FIG. 2 shows an exemplary background image 20 which may correspond to the exemplary document image 10 shown in FIG. 1. In a background image (for example, the background image 20 of FIG. 2), a background region may correspond to a background region in an associated image (for example, the document image 10 of FIG. 1) with the document content removed and the “holes” left by the removed content filled with the local or page background. The page background region 22 in the exemplary background image 20 may correspond to the page background region 12 in the document image 10. The first local background region 24 in the exemplary background image 20 may correspond to the first local background region 14 in the exemplary document image 10. The second local background region 26 in the exemplary background image 20 may correspond to the second local background region 16 in the exemplary document image 10. The third local background region 28 in the exemplary background image 20 may correspond to the third local background region 18 in the exemplary document image 10. Determination of a background image may be desirable for image compression or image analysis.

Some embodiments of the present invention may comprise a limited-context raster method for estimating the local background color at a location in a scanned document image.

In some embodiments of the present invention, local background estimation may be based on color averaging. In alternative embodiments, other color estimators may be used. Exemplary estimators may comprise those based on a median, a weighted average, a trimmed mean and other estimators.

Some embodiment of the present invention may comprise dominant-color summarization within a region.

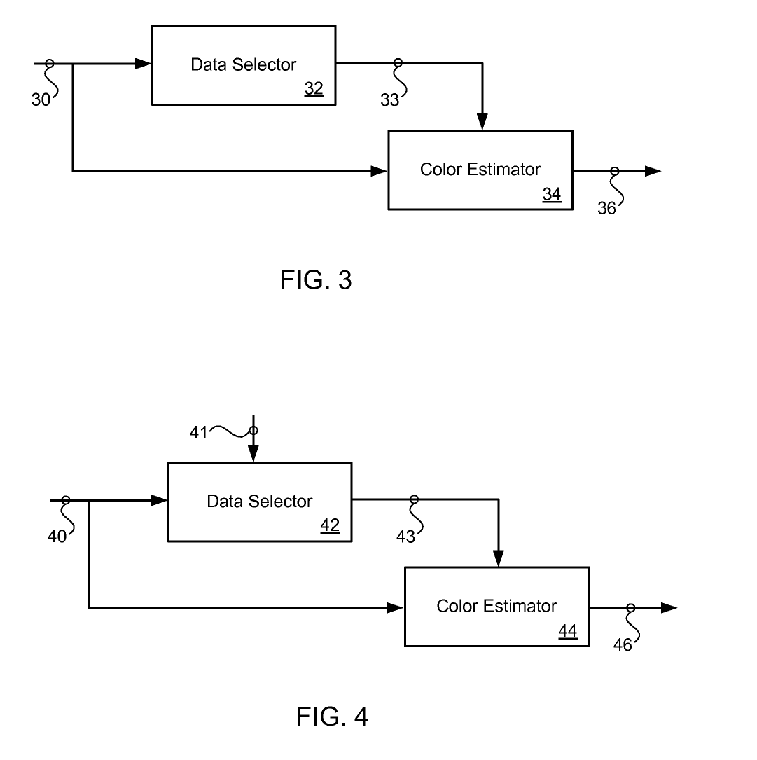

Some embodiments of the present invention may comprise estimation of a local background color at a pixel of interest based on image-data samples in a buffer, wherein the buffer may be populated by sampling a neighborhood of image data around the pixel of interest. These embodiments may be described in relation to FIG. 3. In these embodiments, a data selector 32 may select data from input image data 30. A color estimator 36 may estimate a local background color based on the selected data 33 and the image data 30. In some embodiments of the present invention, the data selector 32 may comprise an image data sampler which may sample image data in a sampling neighborhood proximate to the pixel of interest. In some embodiments of the present invention, the sampling neighborhood may be defined by an M×N rectangular window. In alternative embodiments of the present invention, the sampling neighborhood may comprise a circular region with radius r. Still alternative embodiments may comprise a causal buffer where new data elements may replace sequentially the least current samples so that the buffer may hold the most recent samples according to a sampling order.

In some embodiments of the present invention described in relation to FIG. 4, pixels in the sampling neighborhood may be selectively added to the buffer according to a selection criterion. In these embodiments, a data selector 42 may perform data selection from input image data 40 according to a selection criterion 41. A color estimate 46 may be generated by a color estimator 44 based on the selected data 43 and the image data 40.

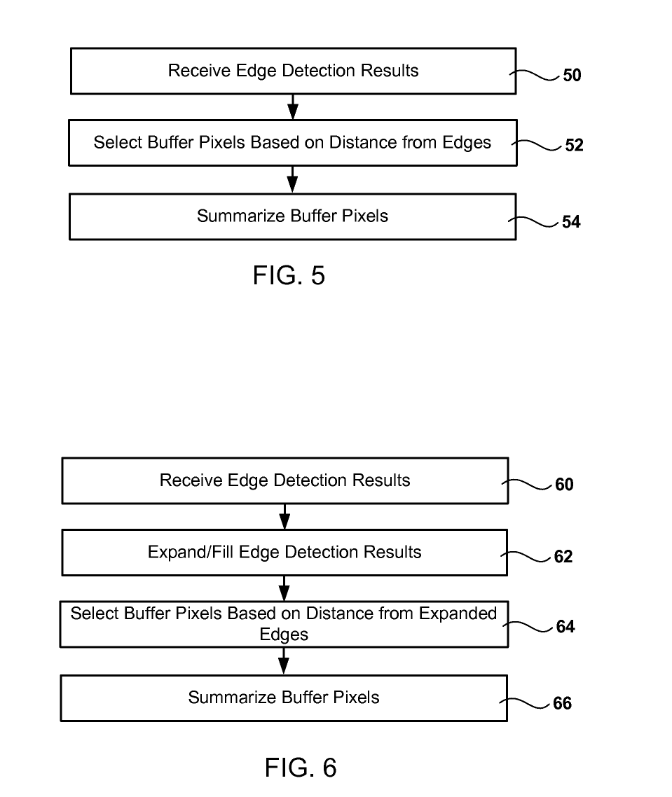

In some embodiments of the present invention described in relation to FIG. 5, the selection criterion may be based on the output of an edge detection algorithm. Edge locations in the original image may be detected 50 based on any standard edge detection methods known in the art. Exemplary edge detection methods may comprise a Sobel edge detector, a Canny edge detector, a Prewitt edge detector and other edge detection methods. The edge locations may be used to identify pixels where sudden transitions in color and, likely, content (e.g., uniform background to text) occur. These transition pixels may be excluded 52 from entry in the color buffer. The background color may be estimated 54 based on the buffer data.

The use of edge detection results may prevent text colors in transition areas from contaminating the local background color estimate. However, the exclusion in the buffer of image data from edge locations may not reduce the negative effects of large font or bold text characters. Excluding the edge pixels from entry into the buffer may not exclude the interior pixels of large font characters from the averaging buffers used to estimate the background. For example, in the interior of large-type text, the color buffer may progressively be dominated by the text color, and the local background color estimate may eventually converge to the text color if enough samples are gathered to fill the color buffer.

To alleviate this problem, in some embodiments of the present invention described in relation to FIG. 6, after edge detection results are received 60, the edge boundaries of text characters may be filled or expanded 62 using image processing techniques. Exemplary image processing techniques for filling or expanding the edge boundaries include morphological closing, flood filling, dilation and other image processing techniques. The results of the filling/expanding process may be used to select 64 pixel data for entry in the buffer. The background color may be estimated 66 based on the buffer entries.

In some memory-limited implementations of the present invention, filling and expanding may not be used.

In alternative embodiments of the present invention, an edge density measure based on a weighted, running difference of the number of edge pixels and non-edge pixels may be used as the selection criterion. This measure may attain a large value near an edge and may gradually decay as the distance from the edge increases. Pixels beyond a set distance away from any edge may be added to the color buffer and used in the local background color estimate.

An edge density signal may be computed from an input edge signal. At each pixel in the input edge signal, a neighborhood may be defined. Within this neighborhood, a summary edge-density signal may be computed. An incoming edge signal may be combined with the neighborhood density signal to form the output edge density signal. Repeating this process over a sequence of image locations may be used to generate an edge density signal at the pixels of interest where a local background signal may be computed.

In some embodiments of the present invention, the edge density measure, edgeden, for each pixel in an input edge signal may be calculated using the following steps:

1. Initialize edgeden values to a known level.

2. Then, for each pixel, (i,j):
a. Set edgeden(i,j) to the maximum of neighboring edgeden values: edgeden=max(neighboring edgeden).
b. Update edgeden(i,j) value using the edge map:

$$edgeden ( i , j ) = \{ \begin{matrix}edgeden ( i , j ) + {w}_{e} , & if edge pixel \\ edgeden ( i , j ) - {w}_{decay} , & otherwise\end{matrix} ,$$

where wₑ may be the accumulation weight if the current pixel is an edge pixel and w_{decay} may be the decay weight for non-edge pixels.
c. Clip negative values and saturate the count at a set maximum value:

$$edgeden ( i , j ) = \{ \begin{matrix}count\_saturate , & if edgeden ( i , j ) > count\_saturate \\ 0 , & if edgeden ( i , j ) < 0 \\ {edgeden}_{i , j} , & otherwise\end{matrix}$$

where count_saturate may be a preset threshold.

Through the parameters w_{decay} and count_saturate, the edge density measure may control how far away from a highly confident edge region a pixel must be before its image value may be added to the buffer and therefore influence the local background color estimate. The parameter wₑ may control the rate at which the edge density measure may obtain highly confident edge region verses sensitivity to noise in the edge detection. The longer the decay, the less likely interior glyph pixels for large or bold fonts will be added to local background color estimate. Conversely, the longer decay, the more pixels it will take for the local background color estimate to converge to a new local background color.

In some embodiments of the current invention, the edge data may be indexed first in left-to-right scan order to set edgeden values for a line, then the edge data may be indexed in right-to-left scan order to refine edgeden values. This may reduce the order dependence of the running sum and may decay the count from both sides of an edge.

In alternative embodiments of the current invention, a binary map of edge or text pixels may be received and pixels that may be labeled as edge or text pixels according to this binary map may be ignored in the background color summarization.

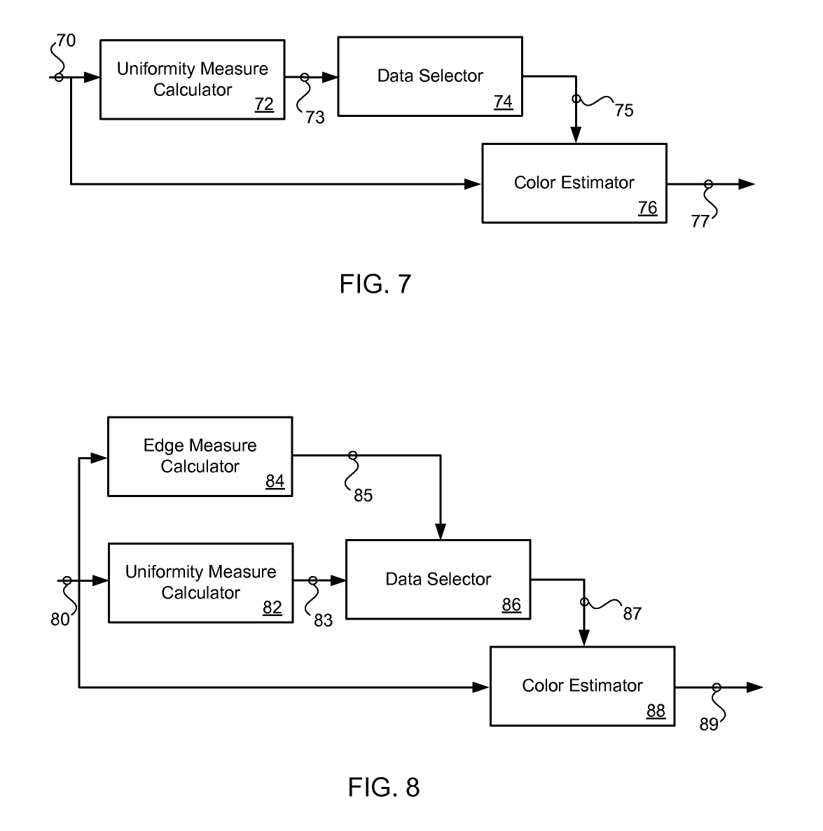

In alternative embodiments of the present invention described in relation to FIG. 7, a uniformity calculator 72 may calculate a uniformity measure which may be used to determine which pixels may be used for background estimation. The uniformity measure 73 may be calculated by the uniformity calculator 72 on input image data 70. The uniformity measure 73 may be used by a data selector 74 for selecting data to be used by a background color estimator 76 in background color estimation which may produce a background color estimate 77. Variance may be an exemplary uniformity measure. A uniformity measure may be negatively correlated to an edge measure, and the uniformity measure may have maxima in different spatial regions. In these embodiments of the present invention, pixels in uniform regions may be considered more-reliable samples for estimating local background colors. In some embodiments of the present invention, the remaining pixels may be labeled as “unknown” and may be ignored by the estimation process. In alternative embodiments, the remaining pixels may be processed using an alternative criterion.

In some embodiments, the uniformity measure may be selected such that textured backgrounds may be labeled as “unknown.” In alternative embodiments, the uniformity measure may be selected such that a textured region may be considered a background region.

In some embodiments of the present invention described in relation to FIG. 8, pixels labeled as “unknown” and whose edge density measure, edgeden (i, j), is sufficiently low may be added to the color buffer and may be used to estimate local background color. This may enable the local background estimate to converge to a close approximation of a smooth (also considered slowly varying) textured, local background region. In these embodiments, a uniformity measure calculator 82 and an edge measure calculator 84 may calculate, from the input image data 80, a uniformity measure 83 and edge measure 85, respectively. These measures may be used by a data selector 86 to determine data 87 from which a color estimator 88 may estimate a local background color 89.

In some embodiments of the present invention, foreground pixels may be assumed to be darker than background pixels. In alternative embodiments of the present invention, foreground pixels may be assumed to be lighter than background pixels. Regions of glyph pixels and regions of text pixels exhibiting this relationship with their background pixels may be referred to as “normal-glyph” regions and “normal-text” regions, respectively. A region in which the local background color is lighter than the glyph color or a region in which the local background color is lighter than the text color may be referred to as a “reverse-glyph” region or a “reverse-text” region, respectively.

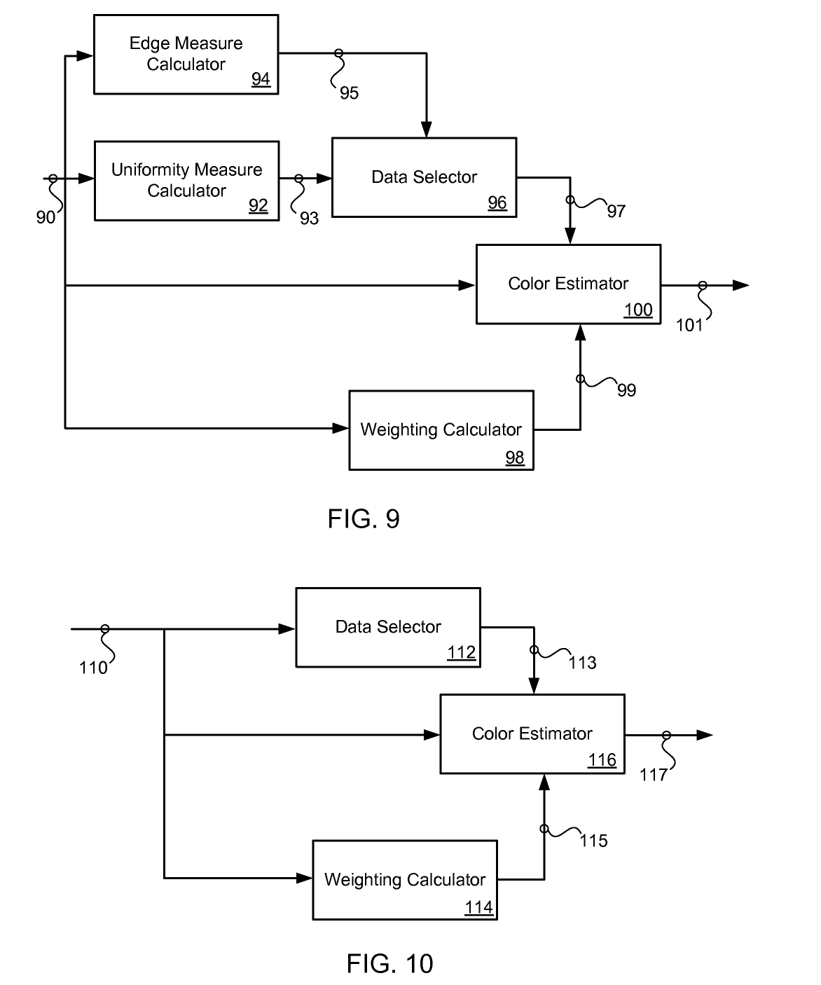

In some embodiments of the present invention described in relation to FIG. 9, a weighting signal 99 may be used by the color estimator 100. In an exemplary embodiment, the local background color estimator 100 may compute a weighted running average, μ, wherein each value, cᵢ, in the buffer may have an associated weight, wᵢ, and where the weights sum to 1:

$$μ = \frac{1}{K} {\sum }_{i = 1}^{K} {w}_{i} {c}_{i} ,$$

where K may be the buffer size.

In the exemplary embodiment shown in FIG. 9, a uniformity measure calculator 92 and an edge measure calculator 94 may calculate, from the input image data 90, a uniformity measure 93 and edge measure 95, respectively. These measures may be used by a data selector 96 to determine data 97 from which a color estimator 100 may estimate a local background color 101. Each selected data 97 may be weighted according to a weighting factor 99 which may be determined by a weighting calculator 98.

In some embodiments of the present invention, in a region identified as a normal-text region, higher weightings may be applied to higher-lightness selected data values. In these embodiments, lower weightings may be applied to lower-lightness values, as these may more likely be lower-lightness foreground pixels.

In alternative embodiments of the present invention, in a region identified as a reverse-text region, higher weightings may be applied to lower-lightness selected data values. In these embodiments, higher weightings may be applied to higher-lightness values, as these may more likely be higher-lightness, reverse-text, foreground pixels.

In some embodiments of the present invention described in relation to FIG. 10, a data selector 112 may select data from input data 110 for entry into a color summarization buffer. The selected data 113 may be used by a color estimator 116 in conjunction with data weightings 115 determined from the input data 110 by a weighting calculator 114 to determine a background color estimate 117.

In some embodiments of the present invention, input image data may be stream-based processed, and as data is passed through the system, limited context may be maintained to minimize memory usage and limit computation time. In these embodiments, a spatial pixel delay may be required to estimate a local background color relative to the pixel of interest passing through the system.

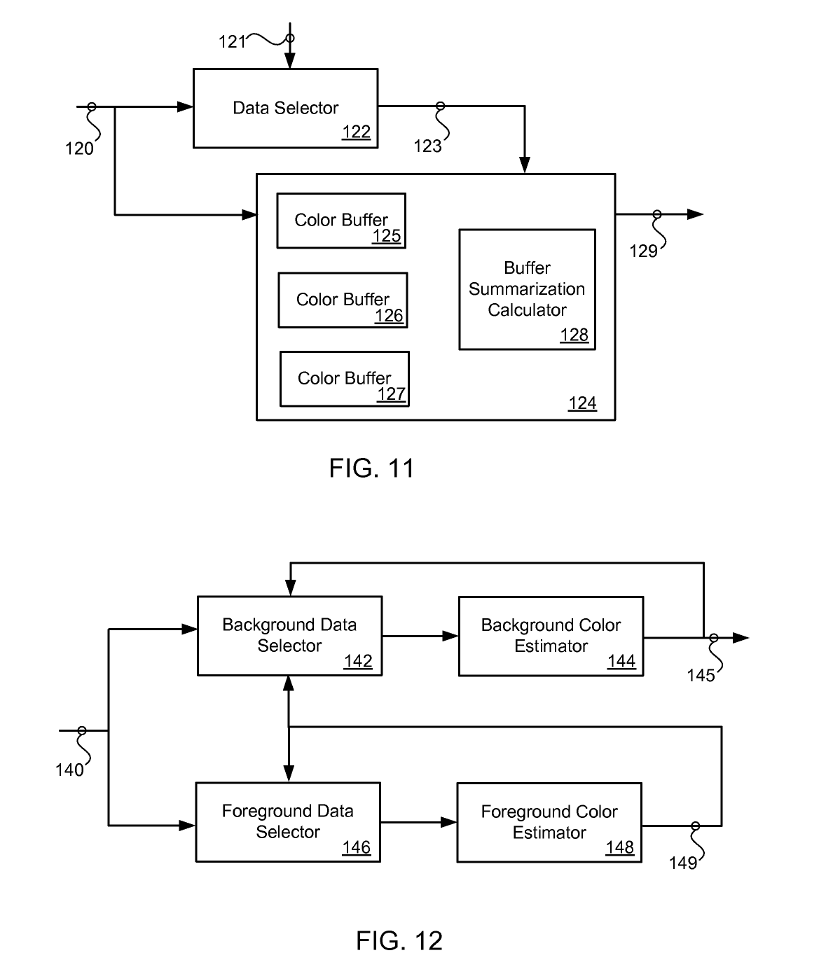

In alternative embodiments, prior analysis may be performed to identify the major background colors in the input image. An exemplary method for identifying major background colors is disclosed in U.S. patent application Ser. No. 11/424,297, entitled “Methods and Systems for Segmenting a Digital Image into Regions,” filed Jun. 15, 2006, which is hereby incorporated herein by reference in its entirety. In these alternative embodiments, a non-local signal may be used in selecting pixels for color summarization. In some embodiments, the major peaks in a global color histogram may be considered likely local background colors. A color buffer may be assigned for each major peak. During background color estimation, each pixel of interest may be analyzed to determine whether it is associated with a major peak. If the pixel of interest is associated with a major peak, then the buffer corresponding to that peak may be updated, and that buffer may be used to estimate the local background color for the pixel of interest. These embodiments may be described in relation to FIG. 11.

In these embodiments, non-local color information 121 may be used by a data selector 122 to determine if an image data value 120 may be added to a color buffer (three shown) 125, 126, 127. The data selector 122 may determine a color-buffer selection signal 123. A local background color estimator 124 may comprise a plurality of color buffers (three shown) 125, 126, 127 and a buffer summarization calculator 128. The buffer summarization calculator 128 may summarize the color data values of the selected color buffer 125, 126, 127. In some embodiments the buffer summarization calculator 128 may comprise a mean calculation, a trimmed-mean calculation, a median calculation, a weighted mean calculation, a weighted trimmed-mean calculation and other estimators. In some embodiments, the non-local color information may comprise peak color values derived from a histogram of the image data.

In some embodiments of the present invention, only pixels whose color is close to a major histogram peak may be added to a color buffer. In these embodiments, the spatial pixel delay required to converge to the local color value may decrease since the colors in the buffer may already be similar to the current pixel of interest.

In some embodiments of the present invention, image data may be buffered and processed multiple times using different scan directions in each processing pass. In some embodiments, multiple lines of a raster image data may be streamed into a processor or ASIC twice: first in raster order and subsequently in reverse raster order. The multiple local background estimates determined from multiple processing of the image data may be reconciled to produce a single estimate at each pixel of interest. In one embodiment each estimate may be used by subsequent processes. In an alternative embodiment, the pixel estimate may be determined by choosing the color estimate closest to the color of the pixel.

In some embodiments of the present invention described in relation to FIG. 12, an estimate of the current foreground object color may be maintained and used in data selection. In these embodiments, if a pixel of interest color value matches the local foreground color estimate, then the pixel of interest color value may receive a lower weighting in the summarization method or the pixel value may be excluded from the background summarization buffers. Simultaneous estimation embodiments such as these may reduce the number of foreground pixels mistakenly added to the background summarization buffers. This may yield better background estimates, uncorrupted by the fringe pixels at boundaries between foreground and background regions.

In these embodiments, a background data selector 142 may select image data 140 based on a selection criterion that incorporates a current foreground color estimate 149. The selected data may be entered into a background color buffer from which a background color estimator 144 may produce an estimate of the local background color 145. In some embodiments of the present invention, the background color estimator 144 may comprise a background color buffer and a buffer summarization calculator. In alternative embodiments of the present invention, the background color estimator 144 may comprise a plurality of color buffers wherein each color buffer may correspond to a peak in a color histogram of the image data 140. In these embodiments, the background data selector 142 may comprise a color-buffer selector. In some embodiments of the present invention, image data 140 that is close in color value to the current foreground color estimate 149 may not be selected by the background data selector 142 for entry into a color buffer. In alternative embodiments, image data 140 that is close in color value to the current foreground color estimate 149 may be weighted less heavily by the background color estimator 144 than image data 140 that is not close in color value to the current foreground color estimate 149.

In some embodiments of the present invention, the foreground color estimate 149 may be determined by a foreground color estimator 148 based on a summary of image color values in a foreground color buffer. A foreground data selector 146 may select image data values 140 that exhibit foreground characteristics for entry into the foreground color buffer.

In some embodiments of the present invention, color similarity may be measured using a distance measurement between color values. Exemplary color-distance measures may comprise an L₁ norm, an L₂ norm, a 2-dimensional city block distance measure between the chroma components of a luma-chroma-chroma color space representation, a 3-dimensional city block distance measure between the components of a 3-dimensional color space representation, a Euclidean distance measure, a weighted 2-dimensional city block distance measure between the chroma components of a luma-chroma-chroma color space representation, a weighted 3-dimensional city clock distance between the components of a 3-dimensional color space representation and other well-known-in-the-art distance measures.

In some embodiments of the present invention, which pixels contribute to a background estimation buffer may be restricted based on a criterion or combination of criterion as described above. In alternative embodiments of the present invention, each buffer entry may be associated with a weighting factor.

In some embodiments of the present invention, the background color estimator may comprise a summarization method which may be biased based on features computed from the background and/or foreground color estimates. In some exemplary embodiments, when the foreground color is lighter than the background estimate, which may occur in a reverse-text region, then the background estimate may be biased darker, and the foreground estimate may be biased lighter. In other exemplary embodiments, when the foreground color is darker than the background color, which may occur in a normal-text region; then the background estimate may be biased lighter, and the foreground estimate may be biased darker.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A system for determining a background color in a digital image, said system comprising:
a. a first buffer;
b. a data selector for selecting data, from a digital image, to be entered in said first buffer; and
c. a color-value estimator for estimating a background-color value based on said data in said first buffer.

2. The system of claim 1, wherein said data selector excludes a data from entry in said first buffer when the location of said data in said digital image is substantially near to an edge in said digital image.

3. The system of claim 1, wherein said data selector includes a data for entry into said first buffer when the location of said data in said digital image is in a region of substantially uniform texture.

4. The system of claim 1 further comprising a weight-factor associator for associating a weighting factor with each entry in said first buffer.

5. The system of claim 1, wherein said first buffer is associated with a first peak in a histogram of color values from said digital image.

6. The system of claim 5 further comprising a second buffer, wherein said second buffer is associated with a second peak in said histogram of color values from said digital image.

7. The system of claim 1, wherein said data selector excludes a data from entry in said first buffer when the color value of said data is substantially close to a foreground object color.

8. The system of claim 1, wherein said color-value estimator comprises a summarization calculator for calculating a calculation selected from the group consisting of a mean, a trimmed mean, a weighted average, a median, a maximum and a minimum of said data in said first buffer.

9. A system for determining a background color in a digital image, said system comprising:
a. a first buffer, said first buffer comprising a first entry corresponding to a first pixel location a digital image;
b. a data-weighting determiner for determining a first weighting factor associated with said first entry in said first buffer; and
c. a color-value estimator for estimating a background-color value based on said first entry and said first weighting factor.

10. The system of claim 9, wherein said data-weighting determiner bases said first weighting factor on a measure of the relative location of said first pixel location and a first edge in said digital image.

11. The system of claim 9, wherein said data-weighting determiner bases said first weighting factor on a uniformity measure in a region substantially proximate to said first pixel location.

12. The system of claim 9, wherein said first buffer is associated with a first peak in a histogram of color values from said digital image.

13. The system of claim 12 further comprising a second buffer wherein said second buffer is associated with a second peak in said histogram of color values from said digital image.

14. The system of claim 9, wherein said data-weighting determiner bases said first weighting factor on a similarity measure between said first entry and a foreground object color.

15. The system of claim 14, wherein said similarity measure comprises a distance calculation selected from the group consisting of a Euclidean distance calculation, a city-block distance calculation and a weighted-distance metric calculation.

16. The system of claim 9, wherein said color-value estimator comprises a weighted-average calculator for calculating a weighted average of said first entry and any additional entries in said first buffer.

17. A method for determining a background color in a digital image, said method comprising:
a. determining a pixel of interest in a digital image;
b. selecting a second plurality of pixels from a first plurality of pixels, wherein said first plurality of pixels are from a first region substantially proximate to said pixel of interest and said second plurality of pixels meet a first criterion;
c. calculating a background-color value based on said second plurality of pixels.

18. The method of claim 17, wherein said first criterion is based on a distance to an edge in said digital image.

19. The method of claim 17, wherein said first criterion is based on a uniformity measure.

20. The method of claim 17, wherein said first criterion is based on a color distance from a foreground color.

21. The method of claim 17 further comprising determining a weighting factor for each of said second plurality of pixels, thereby producing a plurality of weighting factors.

22. The method of claim 21, wherein said calculating is based on said plurality of weighting factors.
